(19) United States
(12) Patent Application Publication
(10) Pub. No.: US 2014/0112702 A1
(43) Pub. Date: Apr. 24, 2014

(54) Pivoting Handle Attachment for Power Tools

(71) Applicant: James L. MIGHELLS, Angelica, NY (US)

(72) Inventor: James L. MIGHELLS, Angelica, NY (US)

(21) Appl. No.: 14/058,976

(22) Filed: Oct. 21, 2013

Related U.S. Application Data
(60) Provisional application No. 61/717,516, filed on Oct. 23, 2012.

(51) Int. Cl. F16C 11/10

(52) U.S. Cl. CPC F16C 11/10
USPC 403/92

(57) ABSTRACT

A pivoting handle attachment for power tools is installed between a power tool and its side handle to provide a means for the side handle to fold into the body of the power tool for storage and ergonomics. Two cylindrical pivot halves have mating serrated faces that are releasably pressed against each other with a bolt and a nut. A threaded stud protruding from the first cylindrical pivot half screws into the existing handle hole in the power tool body, and the side handle screws into the second cylindrical pivot half. To adjust the angle of the handle, the nut is loosened, the handle is rotated to the desired position, and the nut is tightened again.

The current application claims a priority to the U.S. Provisional Patent application Ser. No. 61/717,516 filed on Oct. 23, 2012.

### FIELD OF THE INVENTION

The present invention relates generally to handles. More particularly, the present invention relates to adding adjustability to existing stationary handles used on power tools.

### BACKGROUND OF THE INVENTION

In construction and various other operations relating to the creation or modification or physical items or structures, power tools are ubiquitous. A power tool is a tool that is actuated by an additional power source and mechanism other than the solely manual labor used with hand tools. The most common types of power tools use electric motors, though internal combustion engines and compressed air are also commonly used.

Power tools are used in industry, in construction, in the garden, for housework tasks and various activities such as driving fasteners, drilling, cutting, shaping, sanding, grinding, routing, polishing and more.

Portable power tools have advantages over stationary power tools in mobility. The grip for many portable power tools can be supplemented with a side handle which can be screwed into the body of the power tool. This side handle provides superior control and support of the tool during use, facilitating accuracy of the job done and safety for the user during use.

This setup can pose problems, however. When a power tool is not in use or is being retired after a day's work, it should be properly stored. Storing a power tool with the side handle still attached can pose a problem as the handle extends the boundaries of the tool and makes storing the tool or multiple tools efficiently difficult. One solution to this problem is to remove the side handle before storing the tool, but this opens up the possibility of the handle being lost. In many jobs, workers are responsible for the safekeeping of their tools, and the loss of a handle could mean the loss of a job.

It is therefore an object of the present invention to provide a pivoting handle attachment which can be installed between the existing side handle of a power tool and the body of the power tool which allows the angle of the side handle to be adjusted.

### BRIEF DESCRIPTION OF THE DRAWINGS

FIG. 1 is a perspective view of the present invention with the fastener tightened on the bolt.

FIG. 2 is an exploded view of the present invention.

FIG. 3 is a side view of the present invention with the fastener loosened and the cylindrical pivot halves separated for rotation.

### DETAIL DESCRIPTIONS OF THE INVENTION

All illustrations of the drawings are for the purpose of describing selected versions of the present invention and are not intended to limit the scope of the present invention.

The present invention is a pivoting handle attachment for power tools. The present invention is an apparatus for use with existing power tool handles which provides a simple and economical way for re-positioning a side handle on most hand grinders, power drills and other power tools for better ergonomics and safety. The present invention allows a handle to rotate inward toward the body of a power tool such as a hand grinder or power drill for easy storage, reducing the need to remove the handle from the power tool. By not removing the handle from the power tool, chance of injury or other consequences are greatly reduced. Also reduced is the chance of losing the handle. The present invention may also be commonly known by the name Grip Pivot.

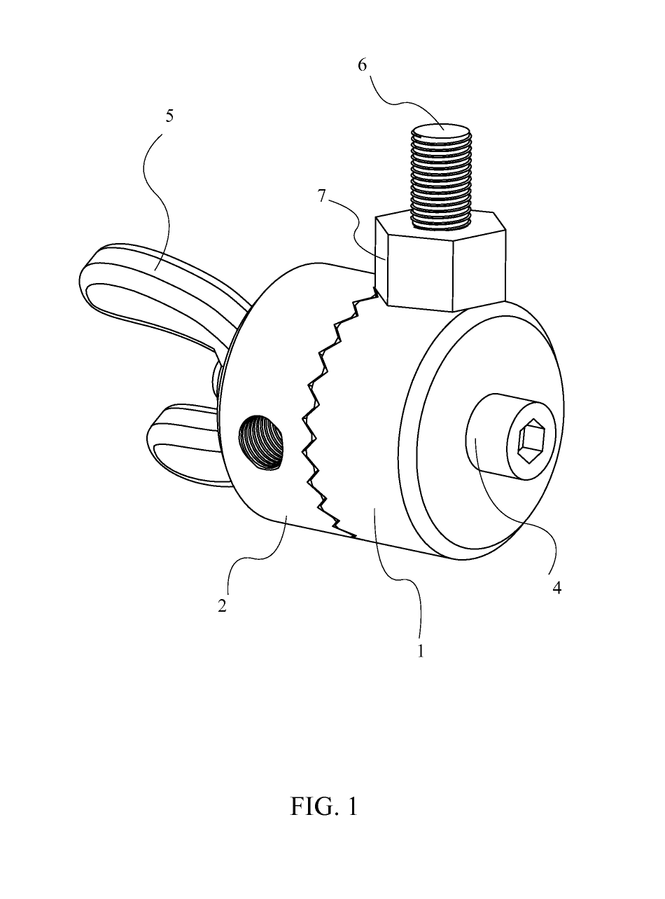

Referring to FIGS. 1-3, the present invention generally comprises a first cylindrical pivot half 1, a second cylindrical pivot half 2, a bolt 4, a fastener 5, and a threaded stud 6. The first cylindrical pivot half 1 and the second cylindrical pivot half 2 are preferably made of 6061 bullet aluminum for durability. However, in alternate embodiments other appropriate materials may be used in the first cylindrical pivot half 1 and the second cylindrical pivot half 2 such as steel, another metal, or a strong polymer. Similarly, the bolt 4, the fastener 5, and the threaded stud 6 are preferably made of metal but may comprise alternate or additional materials. In the preferred embodiment of the present invention, the fastener 5 is a screw threaded nut with internal screw threads. More particularly, in the preferred embodiment of the present invention, the fastener 5 is a wing nut.

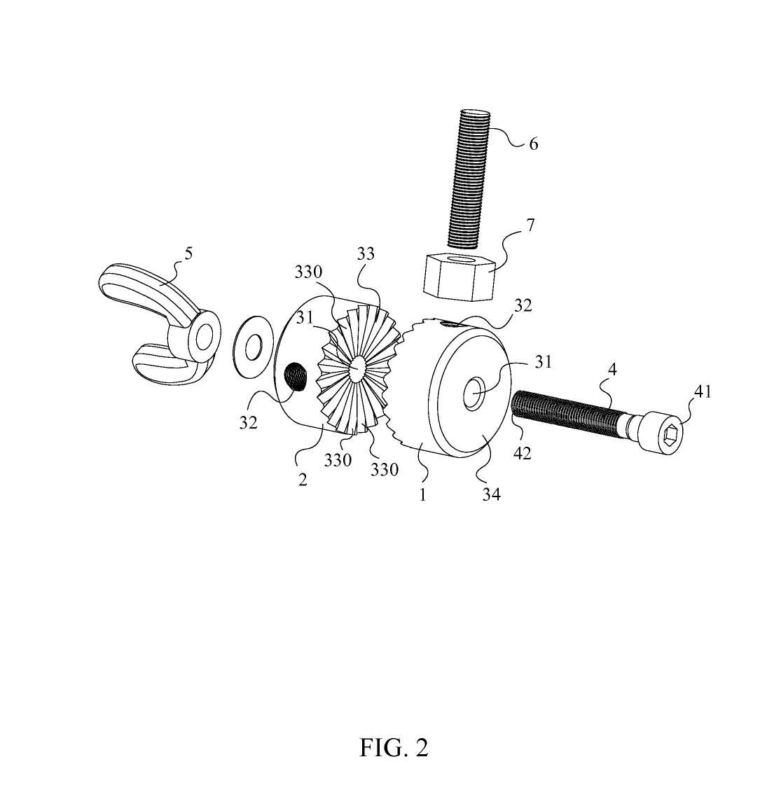

The first cylindrical pivot half 1 and the second cylindrical pivot half 2 are identical. As can be seen in FIG. 2, the first cylindrical pivot half 1 and the second cylindrical pivot half 2 each comprise a bolt aperture 31, a lateral threaded hole 32, and a serrated surface 33. In the preferred embodiment, the bolt aperture 31 is a cylindrical hole centrally traversing through each of the first cylindrical pivot half 1 and the second cylindrical pivot half 2. The bolt aperture 31 of the first cylindrical pivot half 1 centrally traverses through the first cylindrical pivot half 1, and the bolt aperture 31 of the second cylindrical pivot half 2 centrally traverses through the second cylindrical pivot half 2.

The first cylindrical pivot half 1 and the second cylindrical pivot half 2 are positioned concentrically with each other, and are positioned adjacent to each other. The bolt 4 traverses through the first cylindrical pivot half 1 and the second cylindrical pivot half 2, and the fastener 5 is removably engaged with the bolt 4.

The first cylindrical pivot half 1 and the second cylindrical pivot half 2 each further comprise a second surface 34. Preferably, the second surface 34 is substantially flat. However, the flatness of the second surface 34 is not essential to the present invention. The serrated surface 33 is positioned opposite the second surface 34 on each of the first cylindrical pivot half 1 and the second cylindrical pivot half 2. The bolt aperture 31 traverses through the serrated surface 33 and the second surface 34.

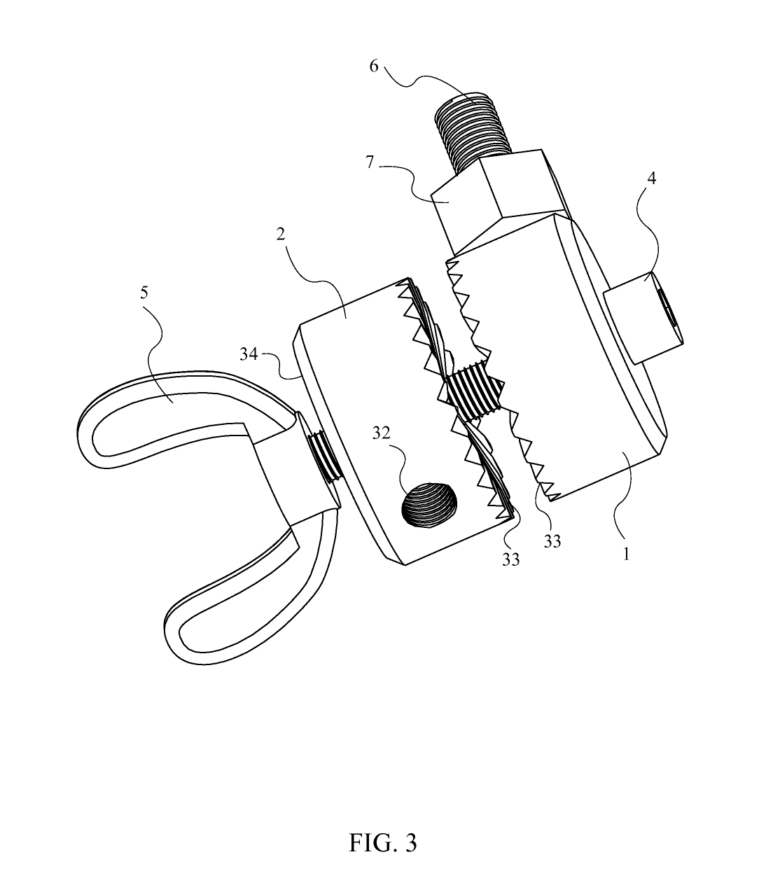

Referring to FIGS. 2-3, the serrated surface 33 comprises a plurality of ridges 330 arranged in a concentric circular pattern around the bolt aperture 31. In the preferred embodiment of the present invention, the plurality of ridges 330 comprises 24 ridges angularly spaced apart from each other by 15 degrees, and a ridge angle between any given two of the plurality of ridges 330 is 90 degrees. However, the plurality of ridges 330 may be comprised in an alternate pattern. The serrated surface 33 of the first cylindrical pivot half 1 and the serrated surface 33 of the second cylindrical pivot half 2 are positioned adjacent to each other, and are releasably pressed against each other by the bolt 4 and the fastener 5.

The plurality of ridges 330 of the first cylindrical pivot half 1 and the plurality of ridges 330 of the second cylindrical pivot half 2 may be interfaced with each other by pressing the serrated surfaces 33 into each other, with peaks and valleys being correspondingly mated together as can be seen in FIG. 1. While the serrated surface 33 of the first cylindrical pivot half 1 is pressed against the serrated surface 33 of the second cylindrical pivot half 2 with sufficient force, the first cylindrical pivot half 1 and the second cylindrical pivot half 2 are prevented from rotating relative to each other due to the plurality of ridges 330 of the first cylindrical pivot half 1 and the plurality of ridges 330 of the second cylindrical pivot half 2 being interlocked with each other.

The lateral threaded hole 32 is oriented perpendicular to the bolt aperture 31. The lateral threaded hole 32 of the first cylindrical pivot half 1 traverses into the first cylindrical pivot half 1 between the serrated surface 33 and the second surface 34. Similarly, the lateral threaded hole 32 of the second cylindrical pivot half 2 traverses into the second cylindrical pivot half 2 between the serrated surface 33 and the second surface 34.

The bolt 4 traverses through the bolt aperture 31 of the first cylindrical pivot half 1 and through the bolt aperture 31 of the second cylindrical pivot half 2. The bolt 4 comprises a head cap 41 and a threaded end 42, which are positioned opposite each other along the bolt 4 as can be seen in FIG. 2. The head cap 41 has a larger diameter than the bolt aperture 31, so that the head cap 41 is impeded from passing through the bolt aperture 31. When the bolt 4 is positioned within the bolt aperture 31 of the first cylindrical pivot half 1 and the second cylindrical pivot half 2, the head cap 41 is positioned adjacent to the second surface 34 of the first cylindrical pivot half 1. The fastener 5 is threadedly engaged to the threaded end 42 adjacent to the second surface 34 of the second cylindrical pivot half 2. To clarify, being threadedly engaged refers to components being mated with each other using screw threads as is commonly known in fasteners. Additionally, a washer should be present between the fastener and the second surface 34.

The preferred embodiment of the present invention further comprises a threaded nut 7, wherein the threaded nut 7 has internal screw threads as commonly utilized with such hardware. It should be made clear that while the threaded nut 7 and the fastener 5 are preferably nuts with internal screw threading, the threaded nut 7 and the fastener 5 are different components. In the preferred embodiment of the present invention, the threaded stud 6 is threadedly engaged within the lateral threaded hole 32 of the first cylindrical pivot half 1 and secured within the lateral threaded hole 32 of the first cylindrical pivot half 1 with a liquid thread locking agent or another adhesive or securing means. In an alternate embodiment, the threaded stud 6 is secured to the first cylindrical pivot half 1 by other means, such as, but not limited to, being originally manufactured with the threaded stud 6 protruding perpendicularly to the first cylindrical pivot half 1. The threaded nut 7 is threadedly engaged with the threaded stud 6. The threaded nut 7 is preferably a locking nut which resists loosening under vibrations and torque. The purpose of the threaded nut 7 is to secure the threaded stud 6 and thereby the rest of the present invention to the body of a tool during use.

In order to use the present invention, a handle is removed from a power tool, wherein the handle is originally provided with the power tool and the handle has a threaded protrusion which normally screws into an existing threaded hole in the power tool. It should be noted that the lateral threaded hole 32 of the first cylindrical pivot half 1 should be threaded in exactly the same way as the existing threaded hole of the power tool in order to accommodate the handle. The threaded stud 6 of the present invention is then screwed into the existing threaded hole, and the threaded protrusion of the handle is screwed into the lateral threaded hole 32 of the second cylindrical pivot half 2. The threaded stud 6 is secured within the existing threaded hole of the power tool through use of the threaded nut 7. The threaded nut 7 is rotated around the threaded stud 6 in a direction which results in translation of the threaded nut 7 in a direction along the threaded stud 6 toward the existing threaded hole. When the threaded nut 7 presses against the casing of the power tool around the existing threaded hole, a portion of the threaded nut 7 deforms elastically to provide a locking action.

As seen in FIG. 3, the fastener 5 is loosened from against the second surface 34 of the second cylindrical pivot half 2, releasing the serrated surface 33 of the first cylindrical pivot half 1 and the second cylindrical pivot half 2 from being pressed against each other. The first cylindrical pivot half 1 and the second cylindrical pivot half 2 can then be rotated relative to each other in order to attain a desired position for the handle. Once the desired position is reached, the fastener 5 is re-tightened against the second surface 34 of the second cylindrical pivot half 2 in order to secure the second cylindrical pivot half 2, and thereby the handle, in the desired position.

Although the invention has been explained in relation to its preferred embodiment, it is to be understood that many other possible modifications and variations can be made without departing from the spirit and scope of the invention as hereinafter claimed.

What is claimed is:

1. A pivoting handle attachment for power tools comprises:
a first cylindrical pivot half and a second cylindrical pivot half;
a bolt;
a fastener;
a threaded stud;
the first cylindrical pivot half and the second cylindrical pivot half being positioned concentrically with each other;
the first cylindrical pivot half and the second cylindrical pivot half being positioned adjacent to each other;
the bolt traversing through the first cylindrical pivot half and the second cylindrical pivot half;
the fastener being removably engaged with the bolt; and
the first cylindrical pivot half and the second cylindrical pivot half each comprise a bolt aperture, a serrated surface, and a lateral threaded hole.

2. The pivoting handle attachment for power tools as claimed in claim 1 comprises:
the bolt aperture of the first cylindrical pivot half centrally traversing through the first cylindrical pivot half; and
the bolt aperture of the second cylindrical pivot half centrally traversing through the second cylindrical pivot half.

3. The pivoting handle attachment for power tools as claimed in claim 1 comprises:
the first cylindrical pivot half and the second cylindrical pivot half each further comprise a second surface;
the serrated surface being positioned opposite the second surface; and
the bolt aperture traversing through the serrated surface and the second surface.

4. The pivoting handle attachment for power tools as claimed in claim 1 comprises:
the serrated surface of the first cylindrical pivot half and the serrated surface of the second cylindrical pivot half being positioned adjacent to each other, wherein the first cylindrical pivot half and the second cylindrical pivot half are releaseably pressed against each other by the bolt and the fastener.

5. The pivoting handle attachment for power tools as claimed in claim 1 comprises:
the first cylindrical pivot half and the second cylindrical pivot half each further comprise a second surface, wherein the second surface is positioned opposite the serrated surface;
the lateral threaded hole being oriented perpendicular to the bolt aperture;
the lateral threaded hole of the first cylindrical pivot half traversing into the first cylindrical pivot half between the serrated surface and the second surface; and
the lateral threaded hole of the second cylindrical pivot half traversing into the second cylindrical pivot half between the serrated surface and the second surface.

6. The pivoting handle attachment for power tools as claimed in claim 1 comprises:
the bolt traversing through the bolt aperture of the first cylindrical pivot half and the bolt aperture of the second cylindrical pivot half.

7. The pivoting handle attachment for power tools as claimed in claim 1 comprises:
the fastener having internal screw threads; and
the fastener being threadedly engaged with the bolt.

8. The pivoting handle attachment for power tools as claimed in claim 7 comprises:
the bolt comprises a head cap and a threaded end;
the head cap and the threaded end being positioned opposite each other along the bolt;
the head cap having a larger diameter than the bolt aperture;
the head cap being positioned adjacent to the first cylindrical pivot half; and
the fastener being threadedly engaged to the threaded end adjacent to the second cylindrical pivot half.

9. The pivoting handle attachment for power tools as claimed in claim 1 comprises:
a threaded nut;
the threaded stud being threadedly engaged within the lateral threaded hole of the first cylindrical pivot half; and
the threaded nut being threadedly engaged with the threaded stud.
